(19) United States
(12) Patent Application Publication
(10) Pub. No.: US 2006/0236949 A1
(43) Pub. Date: Oct. 26, 2006

(54) Pet waste receptacle

(75) Inventors: Kevin C. Hill, Denver, CO (US); Kerry L. Graf, Denver, CO (US)

Correspondence Address: LATHROP & GAGE LC, 4845 PEARL EAST CIRCLE, SUITE 300, BOULDER, CO, 80301, US

(73) Assignee: Hills Home Services, Inc.

(21) Appl. No.: 11/111,025

(22) Filed: Apr. 21, 2005

(51) Int. Cl. A01K 1/035

(52) U.S. Cl. 119/166

(57) ABSTRACT

Provided is a pet waste receptacle including an outer frame and an inner compartment. Positioned within the frame are one or more removable trays having a liquid permeable base. The trays rest atop the inner compartment, and retain a pet attractable cover layer material that allows liquid waste to flow through the liquid permeable base and into the inner compartment. The inner compartment, or a box placed within the compartment, contains a liquid waste absorbing material. The trays may include one or more handles for removing the trays. Further, a support structure and cover may be attached to the outer frame to protect the receptacle from adverse weather. Side and end panels may also be attached to the support structure to partially enclose the receptacle.

### FIELD OF THE INVENTION

This invention relates generally to pet waste receptacles. More particularly, to a functional and aesthetically pleasing pet waste receptacle containing distinct, removable components for separating and segregating liquid waste.

### BACKGROUND

More and more, dog owners are training their pets to use a “litter box” instead of the more traditional use of an outside yard. In many instances, the dog is trained to use the litter box or “pet waste receptacle” placed outside on a deck, porch or in a garage. The receptacle may even be indoors. Many current pet waste receptacles, however, do not provide a sanitary, owner-friendly location for dogs to relieve their bladder and bowels. Receptacles found in the prior art are functionally complex and difficult to clean. Further, many receptacles are not naturally appealing to pets, therefore training a pet to use the receptacle can be an onerous task.

When choosing whether to place a pet waste receptacle indoors or outdoors, protection from the elements of weather should be a consideration. Pet waste receptacles found in the prior art do not adequately provide for covering the receptacle before, during and after use. Further, many receptacles are quite simply aesthetically displeasing, at odds with the decor of the house and/or patio. Also, the focus in the past has been on single breed receptacles. There are receptacles for dogs, or receptacles for cats, however, many prior art systems cannot be easily used for either a cat or a dog. There exists, therefore, a need in pet care industry to provide a pet waste receptacle that overcomes one or more of the drawbacks identified above.

### SUMMARY

The present disclosure advances the art and overcomes problems articulated above by providing a pet waste receptacle.

In particular, and by way of example only, according to an embodiment, provided is a pet waste receptacle including: an outer frame; an inner compartment within the outer frame; a material contained in the inner compartment for absorbing liquid waste; at least one removable tray having a liquid permeable base, the tray positioned within the outer frame and atop the inner compartment to allow liquid waste to pass through the liquid permeable base and into the inner compartment; and a cover layer of pet attractable material resting atop the liquid permeable base.

Also, in one embodiment, provided is a pet waste receptacle including: a means for containing a liquid waste absorbing material; a removable means for retaining a cover layer of pet attractable material, the retaining means positioned atop the liquid waste absorbing material; and a means for separating the retaining means from the containing means, and for ensuring that liquid waste, and not an appreciable quantity of cover layer, passes from the cover layer into the liquid waste absorbing material.

Further, in one embodiment, provided is an improved pet waste receptacle of the type having a frame for containing liquid waste absorbing materials, the improvement including: an inner compartment within the frame; a material contained in the inner compartment for absorbing liquid waste; at least one removable tray having a liquid permeable base, the tray positioned within the frame and atop the inner compartment to allow liquid waste to pass through the liquid permeable base and into the inner compartment; and a cover layer of pet attractable material resting atop the liquid permeable base.

### BRIEF DESCRIPTION OF THE DRAWINGS

FIG. 1 is a perspective view of a pet waste receptacle, according to an embodiment;

FIG. 2 is a top view of a pet waste receptacle with multiple removable trays, according to an embodiment;

FIG. 3 is a sectional view of the pet waste receptacle of FIG. 1, according to an embodiment;

FIG. 4 is the sectional view of FIG. 3 with a cover layer of pet attractable material and a liquid waste absorbing material placed in the receptacle, according to an embodiment;

FIG. 5 is a sectional view of an alternate embodiment of a pet waste receptacle;

FIG. 6 is a sectional view of yet another embodiment of a pet waste receptacle; and

FIG. 7 is a perspective view of a pet waste receptacle having a cover, side panels, and a back panel, according to an embodiment.

### DETAILED DESCRIPTION

Before proceeding with the detailed description, it is to be appreciated that the present teaching is by way of example, not by limitation. The concepts herein are not limited to use or application with one specific type of pet waste receptacle. Thus, although the instrumentalities described herein are for the convenience of explanation, shown and described with respect to exemplary embodiments, it will be appreciated that the principles herein may be equally applied in other types of pet waste receptacles.

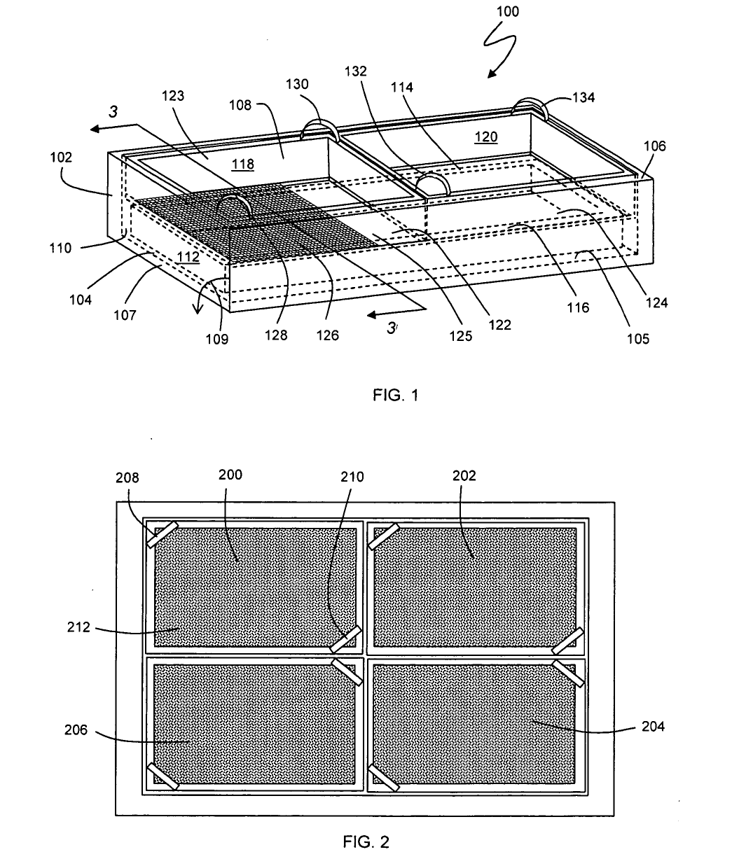

FIG. 1 shows a pet waste receptacle 100 according to an embodiment. As shown, pet waste receptacle 100 includes an outer frame 102 having a base 104, a side wall 106 extending for the perimeter of outer frame 102, and an open end 108 opposite base 104. In one embodiment, side wall 106 includes a hinged section 107 which folds down, as shown by arrow 109. In at least one embodiment, base 104 is a waterproof material. In yet another embodiment, a top surface 105 of base 104 is coated with a waterproof material.

Outer frame 102 may be constructed of any semi-rigid or rigid material to include, but not limited to, wood, metal, plastic, and composite materials. The outer frame 102 of FIG. 1 is rectangular, however it can be appreciated that outer frame 102 may be any of a number of geometric shapes to include: circular, elliptical, and polygonal.

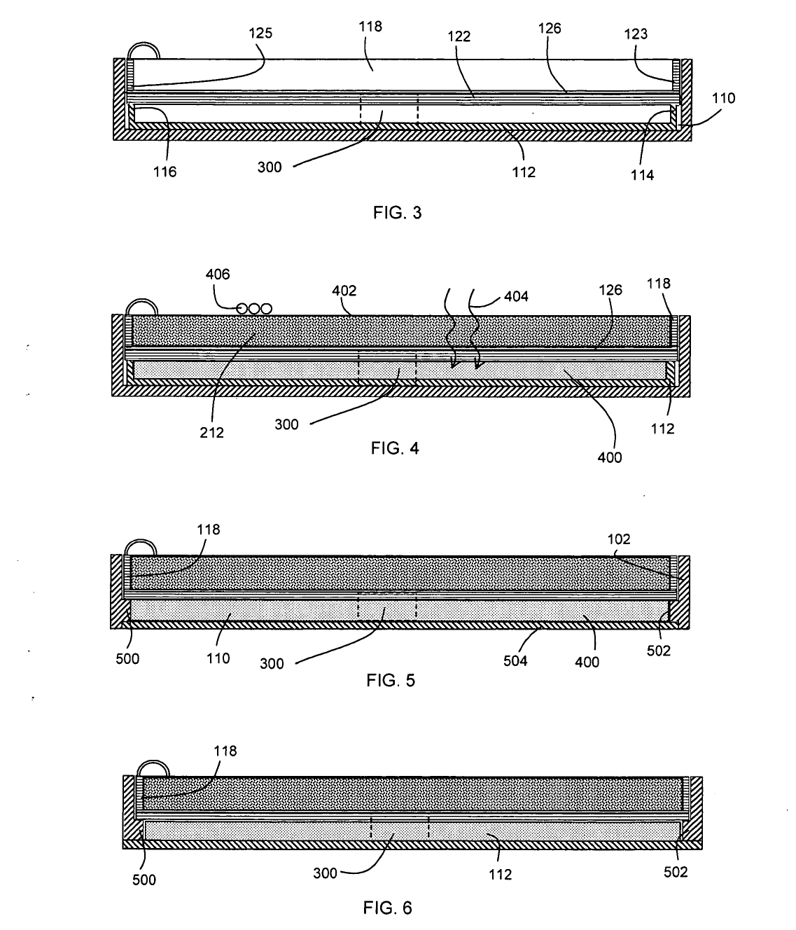

Still referring to FIG. 1, pet waste receptacle 100 includes an inner compartment 110 within frame 102. Inner compartment 110 may be an aperture for containing a liquid waste absorbing material 400 (see FIG. 4). Alternatively, a box 112 may be positioned in inner compartment 110 for containing the liquid waste absorbing material 400. In at least one embodiment, box 112 rests on base 104 of outer frame 102, and is removable as discussed in greater detail below. Cross-referencing for a moment FIGS. 1 and 3, one or more walls of box 112, of which walls 114 and 116 are exemplary, provide support structure for one or more removable trays, e.g. trays 118 and 120. More specifically, base 122 of tray 118 rests upon and is supported by walls 114 and 116. Similarly, base 124 of tray 120 is also supported by walls 114 and 116. In this configuration, removable trays 118 and 120 rest atop box 112 and inner compartment 110. It may also be said that the trays 118, 120 rest atop the liquid waste absorbing material 400 contained in inner compartment 110 or box 112.

Considering now removable trays 118 and 120 in greater detail, bases 122 and 124 are liquid permeable. Stated differently, liquid waste can flow through openings in the bases 122, 124 and into compartment 110 and/or box 112. In this way, the liquid waste can be absorbed by the liquid waste absorbing material 400 contained in compartment 110 or box 112. The openings in bases 122 and 124 are sized to allow the flow of liquid into inner compartment 110 and/or box 112, while also preventing the movement of substantially all solid materials (solid waste, etc.) into inner compartment 110/box 112. In at least one embodiment, the liquid permeable bases 122, 124 include a wire mesh screen 126. As shown in FIGS. 1 and 3, wire mesh screen 126 may be positioned between, and held into place by, base 122 and side walls 123 and 125 of tray 118. A similar mounting scheme may be used with a wire mesh screen (not shown) for tray 120.

Removable trays 118 and 120 may include one or more handles. In at least one embodiment, as shown in FIG. 1, removable tray 118 includes handles 128 and 130, attached at opposite corners of removable tray 118. Likewise, removable tray 120 includes handles 132 and 134, also attached opposite one another. The handles 128, 130, 132, 134 may be used for lifting removable trays 118 and 120 from within frame 102, out through open end 108. Likewise, handles 128, 130, 132, and 134 may be used when placing the trays 118, 120 atop compartment 110/box 112.

Referring now to FIG. 2, it can be appreciated that pet waste receptacle 100 may include a plurality of removable trays positioned within frame 102. As shown, rectangular trays 200, 202, 204 and 206 are positioned adjacent or in close proximity to one another within frame 102. Although trays 200-206 are rectangular, the trays 200-206 may have other shapes as discussed above. Further, trays 200-206 may include one or more handles, e.g. handles 208 and 210 on tray 200. Placed within trays 200-206 is a cover layer of pet attractable material 212, resting atop of a liquid permeable base (not shown). In at least one embodiment, cover layer 212 is pea gravel. In yet another embodiment, cover layer 212 is selected from a group which includes pea gravel, synthetic sod, natural sod, wood pellets, and mulch. The list of materials provided above is not all-inclusive. Cover layer 212 may be any of a number of pet attractable materials selected to allow the flow of liquid waste from tray 200 to the liquid waste absorbing material below. Also, cover layer 212 is selected to retain, substantially on a top surface 402 (FIG. 4) of cover layer 212, any solid waste.

In FIG. 3, a cross-sectional view of pet waste receptacle 100 is presented, as viewed along line 3-3 in FIG. 1. As discussed previously, tray 118 rests atop compartment 110 and box 112, supported by walls 114 and 116. Liquid permeable base 122, which includes wire mesh screen 126, may be supported by a support block 300 positioned within compartment 110 or box 112. One or more support blocks may be used to support base 122, especially when a substantially large surface area of base 122 includes wire mesh screen 126.

In FIG. 4, the cross-sectional view of FIG. 3 is shown with liquid waste absorbing material 400, as well as pet attractable cover layer material 212 included. As shown, tray 118 and box 112 are substantially full with pet attractable cover layer material 212 and liquid waste absorbing material 400 respectively. Liquid waste absorbing material may be selected from a group including cat litter, dog litter, wood pellets, floor dry, and saw dust. Liquid waste, as represented by lines 404, is allowed to flow through pet attractable cover layer material 212, through wire mesh screen 126 and into liquid waste absorbing material 400. Solid waste 406 is retained substantially on the top surface 402 of pet attractable cover layer material 212.

Referring now to FIGS. 5 and 6, alternate embodiments of pet waste receptacle 100 are presented. In one embodiment, FIG. 5, tray 118 is positioned atop compartment 110 and supported by shelves 500 and 502 of frame 102. Liquid waste absorbing material 400 is contained within compartment 110, and there is no box 112. Frame 102 may include a base 504 which is a separate, removable section of the frame 102. The functional aspects of this embodiment are substantially the same as those discussed above, and tray 118 is removable to allow access to compartment 110 for cleaning, etc.

In FIG. 6, tray 118 still rests upon shelves 500 and 502, however, removable box 112 is positioned in compartment 110. In one embodiment, box 112 is removed from above, once tray 118 has been removed. In yet another embodiment, box 112 is removed through the side access provided by hinged section 107 (FIG. 1). Side removal allows access to box 112 while maintaining tray 118 in its operational position.

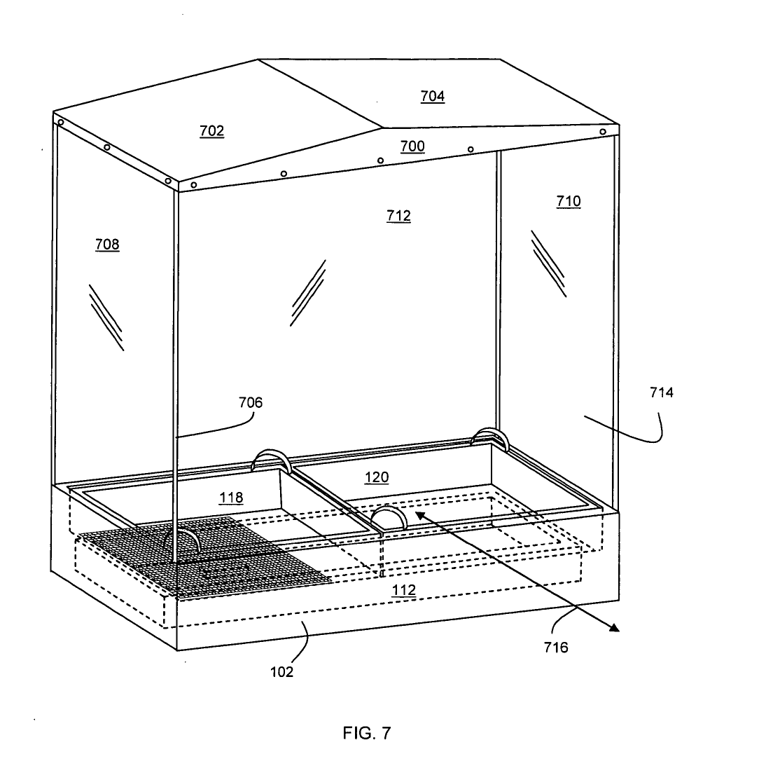

As shown in FIG. 7, pet waste receptacle 100 may include a cover 700 for protecting frame 102, trays 118, 120 and box 112 from adverse weather conditions, to include rain, snow, sunlight, etc. In at least one embodiment, cover 700 may include sloped surfaces, e.g. surfaces 702 and 704. Sloped surfaces 702, 704 allow rain and other moisture to flow off of cover 700 toward the ground, thereby preventing damage to, or distortion of, cover 700 from the weight of the moisture. The cover 700 may be made of canvas, plastic, or other materials. Cover 700 is supported and held in position by a support structure 706 attached to frame 102. In addition to cover 700, support structure 706 may support one or more panels, of which side panels 708 and 710, and back panel 712 are exemplary. The panels may be made of Plexiglas, other semi-transparent or transparent materials, or such other materials as provide protection from the elements. In the embodiment shown in FIG. 7, ingress and egress of pet waste receptacle 100 is through open front 714, in the directions indicated by arrow 716.

Operationally, compartment 110 or box 112 is substantially filled with liquid waste absorbing material 400. One or more trays 118, 120 are then positioned atop compartment 110/box 112 and filled with pet attractable cover layer material 212. After a period of use determined by the pet owner, trays 118, 120 are removed and cleaned by removing solid waste and washing the pet attractable cover layer material 212 with water, etc. Alternatively, pet attractable cover layer material 212 may be replaced with new material. Similarly, compartment 110 or box 112 may be cleaned by periodically replacing the liquid waste absorbing material 400.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

1. A pet waste receptacle comprising:
an outer frame;
an inner compartment within the outer frame;
a material contained in the inner compartment for absorbing liquid waste;
at least one removable tray having a liquid permeable base, the tray positioned within the outer frame and atop the inner compartment to allow the liquid waste to pass through the liquid permeable base and into the inner compartment; and
a cover layer of pet attractable material that can be periodically washed and reused, said cover layer resting atop the liquid permeable base.

2. The receptacle of claim 1 wherein the outer frame includes a base coated with a waterproof material.

3. The receptacle of claim 1, wherein the outer frame and the at least one removable tray are substantially rectangular.

4. The receptacle of claim 1, wherein the liquid permeable base includes a wire mesh screen.

5. The receptacle of claim 1, further comprising one or more handles fastened to the at least one removable tray for removing the tray from the outer frame.

6. The receptacle of claim 1, further comprising a removable box positioned within the inner compartment for containing the liquid waste absorbing material.

7. The receptacle of claim 1, further comprising a plurality of removable trays positioned in close proximity to one another within the outer frame.

8. The receptacle of claim 1, wherein the cover layer of pet attractable material is selected from a group consisting of: pea gravel, synthetic sod, natural sod, wood pellets, and mulch.

9. The receptacle of claim 1, wherein the material for absorbing liquid waste is selected from a group consisting of: cat litter, dog litter, wood pellets, floor dry, and saw dust.

10. The receptacle of claim 1, further comprising:
a cover positioned above the outer frame for protecting the outer frame, the inner compartment, and the at least one removable tray from adverse weather, and
a support structure mounted to the outer frame for holding and supporting the cover.

11. The receptacle of claim 10, wherein the cover includes one or more sloped surfaces to facilitate drainage of water from a top surface of the cover.

12. The receptacle of claim 10, further comprising at least one panel mounted to the support structure.

13. The receptacle of claim 12, further comprising:
a first end panel;
a second end panel positioned substantially parallel to the first end panel; and
a back panel mounted substantially perpendicular to the first and the second end panels to interconnect the first and second end panels.

14. A pet waste receptacle comprising:
a containing, means for containing a liquid waste absorbing material;
a removable means for retaining a cover layer of pet attractable material that can be periodically washed and reused, the retaining means positioned atop the liquid waste absorbing material; and
a means for separating the retaining means from the containing means, and for ensuring that liquid waste, and not an appreciable quantity of cover layer, passes from the cover layer into the liquid waste absorbing material.

15. The receptacle of claim 14, wherein the separating means is a liquid permeable panel positioned between the retaining means and the containing means.

16. The receptacle of claim 14, further comprising one or more handles fastened to the retaining means for removing the retaining means from atop the liquid waste absorbing material.

17. The receptacle of claim 14, further comprising:
a first end panel;
a second end panel positioned substantially parallel to the first end panel;
a back panel mounted substantially perpendicular to the first and the second end panels to interconnect the first and second end panels;
a support structure for holding the first, the second and the back panels; and
a cover mounted to the support structure for covering and protecting the containing means, the retaining means and the separating means.

18. The receptacle of claim 15, wherein the liquid permeable panel includes a wire mesh screen.

19. An improved pet waste receptacle of the type having a frame for containing liquid waste absorbing materials, the improvement comprising:
an inner compartment within the frame;
a material contained in the inner compartment for absorbing liquid waste;
at least one removable tray having a liquid permeable base, the tray positioned within the frame and atop the inner compartment to allow liquid waste to pass through the liquid permeable base and into the inner compartment; and
a cover layer of pet attractable material that can be periodically washed and reused, said cover layer resting atop the liquid permeable base.

20. The improved pet waste receptacle of claim 19, further comprising:
a cover positioned above the frame for protecting the frame, the inner compartment, and the at least one removable tray from adverse weather; and
a support structure mounted to the frame for holding and supporting the cover.
